(19) United States
(12) Patent Application Publication
(10) Pub. No.: US 2012/0253999 A1
(43) Pub. Date: Oct. 4, 2012

(54) INVOICING MANAGEMENT METHOD AND SYSTEM

(75) Inventors: Gregory Labrousse, Paris (FR); Jean Cazes, Paris (FR)

(73) Assignee: TAXEO, Paris (FR)

(21) Appl. No.: 13/500,137

(22) PCT Filed: Oct. 5, 2009
(86) PCT No.: PCT/FR09/01184

§ 371 Date: Jun. 21, 2012

(51) Int. Cl. G06Q 40/00

(52) U.S. Cl. 705/31; 705/40

(57) ABSTRACT

An invoicing management method and system for an electronic transaction relating to the purchase of goods and/or services by a bearer, characterised in that it has the following steps: collection of at least one bearer-identification element contained in a data medium by the reading device of a terminal; retrieval of an ordered set of data elements corresponding to the transaction characteristics from a previously downloaded application interface and input device of the terminal; transmission of the at least one identification element and the ordered set of retrieved data elements to a central server; generation of an electronic invoice by the processing device of the central server, on the basis of identification data associated with the identification element in a database of the server and the ordered set of retrieved data elements; and archiving of the electronic invoice in the database of the central server.

### BACKGROUND

1. Technical Field of the Invention

The invention relates to a method and system for managing invoicing in a communication network.

The present system relates to the field of electronic transaction mechanisms for archiving information relating to purchases of services or goods.

2. Prior Art

In general terms, when a good and/or a service is purchased from a merchant, the client is invited, after having selected the good or service that he wishes to acquire, to make payment for this purchase by providing bank details of his credit card so that the transaction is performed, or by cheque or in cash.

In the context of this transaction, the merchant delivers to him an invoice, which is an accounting document by means of which this merchant establishes a debt, resulting from the supply of the good and/or the performance of the service, vis-à-vis the customer benefitting from this good and/or service provision.

However, the format of this document makes it difficult to carry out the management that may be made subsequently of this invoice by a private individual or a company.

A general problem is then posed of improving the invoicing management processes for invoice documents obtained during transactions for the purchase of goods and/or services so as to accelerate and facilitate all the processing operations that may be carried out on such documents.

The document US 2007/0005510 is known in the prior art, which describes a system of managing invoices and an associated device for managing electronic invoices. This document provides a device for centralising and storing invoices. This invention describes the use of a mobile data storage means, for example a USB key, so that a purchaser can store his electronic invoices.

Another document US 2003/0126020 is also known in the prior art and describes a system for managing and issuing invoices providing a means of receiving the electronic invoices, essentially wireless, to enable a customer to store his electronic invoices in a mobile unit.

However, one of the major drawbacks of these systems is not allowing precise identification of the bearer enabling a personalised invoice to be established.

### SUMMARY OF THE INVENTION

The present invention aims to solve the problem relating to the technical difficulties encountered for automatically generating in real time an invoice in an electronic format, during a transaction, taking account of accounting requirements.

In addition, the present invention makes it possible to centralise all the invoices issued by various merchants, in different countries, while guaranteeing confidentiality by limiting the risks of losses of information as well as exhaustiveness of the information necessary for issuing a standard invoice in a way that is optimised in terms of time and cost.

Finally, the present invention also makes it possible to generate questions according to the combination between the parameterising of the reading terminal of the merchant and certain elements of the element identifying the bearer, and to transmit the corresponding replies in relation to the elements that will make it possible to establish said invoices.

For this purpose, one aspect of the invention relates to a method of managing invoicing for an electronic transaction relating to the purchase of a good and/or service by a bearer, said method comprising the following steps:
collecting at least one element identifying the bearer included in a data carrier by means of reading a terminal;
recovering an ordered set of data elements corresponding to the characteristics of said transaction from an application interface previously downloaded and entry means of a terminal;
transmission of this at least one identification element and the ordered set of data elements recovered to a central server;
generation of an invoice in an electronic format by the processing means of the central server from identification data associated with the identification element in a database of this server and the ordered set of data elements recovered, and
archiving of said invoice in an electronic format in the database of the central server.

According to particular embodiments:
the data recovery step comprises a substep of selecting elements constituting said application interface according to at least one criterion defined by said identification element, said selection of elements making it possible to obtain the ordered set of data elements corresponding to the characteristics of said transaction;
the method comprises a preliminary step of registration:
of the bearer in which the identification data associated with the identification element of the bearer are recorded in the database of the central server,
of the merchant, for which an individual identification number is created and archived in the database of the central server;
the identification data relate, in the database of the central server, to the first name and surname, the name of the company employing the bearer, and the physical and electronic address of the bearer and company;
the invoice in an electronic format is archived in the database of the central server;
the method comprises a step of transmitting the invoice in an electronic format to a processing server of the company;
the ordered assembly of recovered data elements comprises information concerning:
the merchant: individual identification number;
the bearer: identifier;
the transaction: the date and number of the transaction, the quantity and name of the goods and/or services sold, the financial elements: the amount excluding and/or including VAT of the goods and/or services sold, the tax applicable, any discounts;
responses to specific questions posed according to the context of the transaction;
the method comprises a step of management of reimbursement of data relating to said tax in which:
the company employing the bearer transmits to the central server a request for recovering said tax through the communication network,
the central server determines whether the invoice in an electronic format is eligible for a reimbursement of said tax, and
the central server sends, through the commutation network, at least one request for reimbursement of said tax to reimbursement servers dedicated to this tax, said request being able to consolidate several invoices in the name of the same business,
the tax is VAT (value added tax).

The invention also relates to a system for managing invoicing for an electronic transaction relating to the purchase of a good and/or service by a bearer, comprising a terminal connected to a central server from a communication network, and in which the terminal comprises reading means for extracting at least one identification element for a data carrier and archiving this identification element and an ordered set of data elements relating to the transaction in storage means of the terminal before transmitting them to the processing means of the central server so as to generate an invoice in an electronic format relating to said transaction and if necessary sending a message confirming the making of the payment validating the performance of said transaction.

In a particular embodiment the terminal is an electronic payment terminal.

In another embodiment, the data carrier is an integrated-memory identification card.

### BRIEF DESCRIPTION OF THE DRAWINGS

Other features and advantages of the invention will emerge from a reading of the following description with reference to the accompanying figures, which illustrate:

FIG. 1, a schematic view of the structure of the invoicing management system, and

FIG. 2, a diagram defining the steps of a method of managing invoicing data used by the system in FIG. 1.

For more clarity, identical or similar elements are marked by reference signs identical over all the figures.

### DETAILED DESCRIPTION OF THE PREFERRED EMBODIMENT(S)

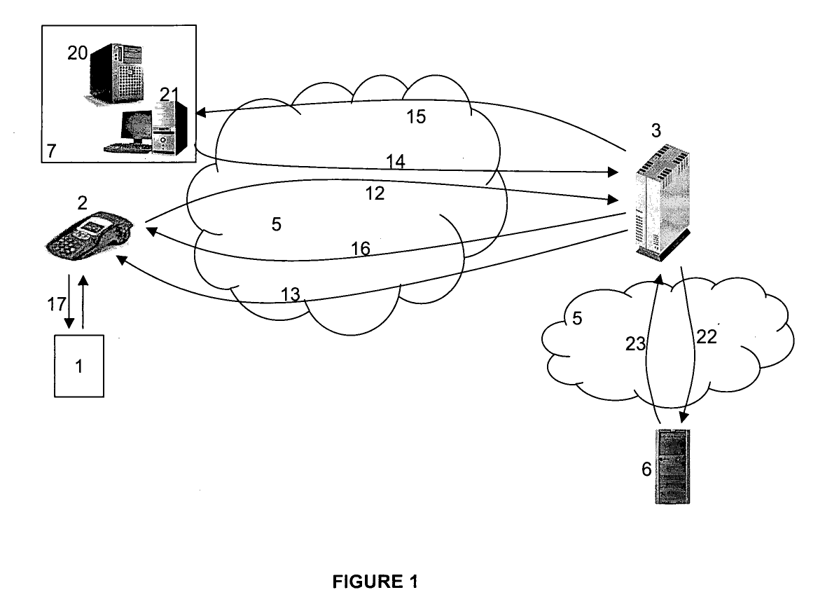

In an example embodiment of the system according to the invention, FIG. 1 shows a system comprising:
a data carrier 1;
a terminal 2;
a central server 3;
a technical platform of a company 7;
a tax reimbursement server 6, and
a communication network 5.

This data carrier 1 may be, non-exhaustively:
an integrated-memory identification card, such as a payment card associated with one of the following elements:

a bank card and/or a credit account of the user, a bank card and/or an electronic purse and/or all types of electronic payment media or means;
a magnetic strip card,
a chip card,
an RFID (radio-frequency identification) or NFC (near field communication) chip, and
a magnetic card.

This data carrier may comprise a memory means for storing an identifier.

It should be noted that, in certain embodiments, the method, when it is integrated in a payment card, enables the bearer to use the same card twinned for the two functions, automated online invoicing, and payment.

Likewise, in other embodiments, the method can be associated with specific loyalty programmes.

In another embodiment, this data carrier may be a sheet of paper comprising the identifier of the bearer.

The terminal 2 relates to an item of equipment comprising reading means compatible with the data carrier 1. In the case of the identification card, this equipment corresponds to an electronic payment terminal 2.

More generally this terminal 2 relates to all items of equipment comprising:
at least one microprocessor,
volatile and/or non-volatile and/or mass memory,
entry means, such as a keyboard and/or a mouse and/or a touch screen or voice control means,
display means,
communication means, and
reading means.

The communication means of this terminal 2 relate for example to the following technologies and/or standards:
Bluetooth and/or IrDA (Infrared Data Association), and/or WiFi (the abbreviation for wireless fidelity) and/or Wimax, and
GPRS (General Packet Radio Service), GSM, UMTS, HSDPA or IMS (IP Multimedia Subsystem).

The reading means are able to exchange data with the data carrier.

This terminal 2 comprises communication means that are compatible with those of the identification card and of the central server 3.

The central server 3 comprises a database containing data relating to user identification elements and to identification data respectively associated with each of these identification elements.

These identification data relate non-exhaustively to:
a physical person:
marital status;
surname;
first name;
address (residence);
telephone details;
post code (residence);
payment method (for example bank card number, bank account details);
electronic address;
function of the bearer in the company;
name of the company employing the bearer;
physical and electronic address of the company;
company registration number;
legal form;
share capital;
SIREN number; and
individual identification number;
a legal person;
name of the company;
physical and electronic address of the company;
company registration number;
legal form;
share capital;
SIREN number;
individual identification number;
telephone details; and
post code.

The central server 3 comprises a database containing data relating to merchants.

These identification data relate non-exhaustively, for a merchant, to:
name of the company of the merchant;
physical and electronic address of the company;
company registration number;
legal form;
share capital;
SIREN number;
individual identification number;
telephone details; and
post code.
contact details at the merchant
bank details
services rendered
information relating to its terminals
membership of a group or network.

The central server 3 comprises a web server able to generate web pages in order to enable the bearer and the merchant to be able to subscribe to the service offered by the central server 3 and therefore to create an account with this central server 3 in order in particular to have access to the archived electronic invoices concerning them.

This central server 3 also comprises an email server for managing electronic mail and also a messaging server (SMS, MMS, WAP).

This central server 3 comprises communication means enabling it to exchange data with:
a terminal 2;
a technical platform of a company 7, and
a tax reimbursement server 6.

The communication network 5 used relates to cabling means and/or electromagnetic transmission means. Without claiming to make an exhaustive list, these cabling means correspond for example to optical fibre or copper cables, and the electromagnetic transmission means relate for example to radio links based on mobile telephony standards such as GSM (the acronym for Global System for Mobile Communications), UMTS (the acronym for Universal Mobile Telecommunications System), EDGE (the acronym for Enhanced Data Rates for GSM Evolution) or HSDPA (the acronym for High-Speed Downlink Packet Access). These means may also relate to technologies such as WiFi defined by the IEEE 802.11 standards or Bluetooth defined by the IEEE 802.15 standards, or Wimax (the acronym for Worldwide Interoperability for Microwave Access) defined by IEEE 806.16.

The technical platform of the company of the bearer in the case where the bearer is a physical person comprises a server and terminal set making it possible both to connect to the central server 3 in order for example to register the company or the bearer with the service provided by the central server 3, or to consult the invoices in an electronic format generated for the transactions made by various bearers therefore having a different identification element. In the latter case these bearers are employed in this same company.

The tax reimbursement server 6 is a server located in the technical platform of a tax authority of a State and is connected to the central server 3 in order in particular to transmit requests containing data relating to information concerning the reimbursement of certain taxes for given invoices.

These taxes are for example VAT (Value Added Tax) in France or equivalent taxes when the transaction is carried out outside French territory.

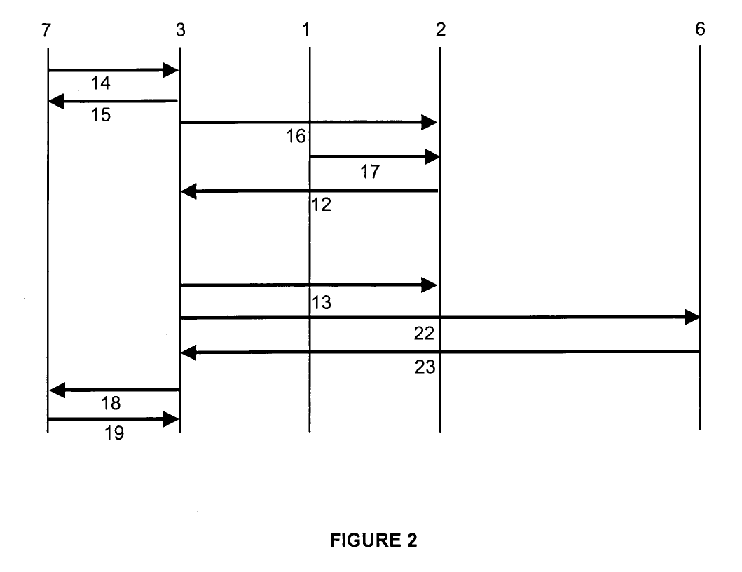

FIG. 2 illustrates the electronic transaction method for the purchase of goods and/or services by the bearer of a data carrier 1.

This bearer may be a legal or natural person.

In a preliminary step, during data exchanges 14, 15, the bearer connects from a computer 21 to the web server of the central server 3 so as to proceed with his registration to the service provided by this central server 3.

At the time of this registration, the bearer has to complete, by entering his identification data, an electronic form generated by his web browser.

These identification data are recorded in the data base of the central server 3.

According to this same procedure, the merchant must also register and thus have access to the invoices in an electronic format archived at the central server.

The identification element is generated and is subsequently archived in the database and transmitted to the memory means of the data carrier 1.

This identification element corresponds for example to a succession of characters coded according to a predefined list thus making it possible to determine, from the identification element and non-exhaustively: the country, or the language of the bearer, the activation or not of the method nationally or internationally, the activation or not of a request to allocate the expenditure to a project code, the activation or not of a search for information in real time at the central server.

This data carrier 1 is either:
already in the possession of the bearer and therefore the transmission of this identification element is carried out remotely, that is to say from the central server 3 to the device to which the data carrier is connected at the bearer, and is then archived in the memory means of this data carrier, or
once the identification element is loaded, the carrier is sent by post for the attention of the bearer to his personal address or to that of the company where he is employed.

During a transaction 16, the electronic payment terminal 2 downloads a software application that is the subject of particular processing by the processing means of the terminal 2, the memory means and the processor, with a view to generating, on the display means of this terminal 2, an interface with which the merchant can interact using the entry means of this terminal 2.

This software application may also be already installed on the terminal of the merchant by the manufacturer of the terminal, or downloaded and installed after the merchant activates his account at the central server 3.

This activation is done by entering his identification element on the terminal or inserting his data carrier in the reading means of the terminal, said terminal then being connected to the central server 3 in order to transmit this identification element with a view to being identified and thus effect this downloading.

The bearer connects the data carrier 1, in the present case his magnetic-strip card, to the electronic payment terminal. During a step 17, the means of reading the electronic terminal 2 extract the identification element, that is to say the identification element in the memory means of the magnetic-strip card, and archives it the memory means of the terminal 2.

The software application is a digital data file that is archived in the database of the central server and, when it is executed by the processing means of the terminal, is able to present information on the display means of the terminal in many different languages.

The content of this interface relates to elements such as for example questions included in a form that the merchant is invited to complete by entering all the data elements corresponding to the characteristics of said transaction.

These elements relate for example, non-exhaustively, to information relating to the merchant, to the bearer and to financial elements. This information is therefore:
the total amount of the invoice
the quantity and amount of each type of service invoiced
types of questions posed and responses to said questions
the elements constituting the interface, relating for example to questions, were generated from a selection from a plurality of elements archived in the memory means of the terminal, coming from the software application. This selection is made from the processing means of the terminal on the basis of at least one criterion relating to the identification element, and more particularly to the coding of this identification element.

It is on the basis of this selection of elements constituting the interface that the ordered set of data elements corresponding to the characteristics of said transaction is obtained.

The data are then archived in the memory means of the electronic payment terminal 2.

The data archived in the memory means of the electronic payment terminal 2, that is to say the identification element and the ordered set of data elements recovered, are transmitted to the central server 3, during a step 12.

The data elements are said to be ordered since they are transmitted in the order in which they were entered. This has the effect of improving the transmission, processing and archiving time subsequently at the central server 3.

In another embodiment, these elements are not ordered.

The processing means of the central server 3 subsequently generate an invoice in an electronic format relating to this transaction from identification data associated with the identification element in the database of this central server 3 and the ordered set of data elements recovered.

This invoice is perfectly in accordance with the requirement of the local tax authorities, that is to say the authorities of the place of the transaction.

This invoice is issued by means of consolidation of the data relating to the transaction, those that are related to the identity of the merchant and of the bearer of the card. Collecting complementary data from the interface having a form in the form of responses to simple questions defined according to the contacts is necessary. This collection normally takes place at the time of the act of payment, both in order to avoid an additional step for the parties concerned and to benefit from the subscription technology deployed for the payment: portable terminals, central tills, etc.

The challenge of the solution is to reduce to a strict minimum the time necessary for entering the data and to obtain all the information necessary but only this. This is made possible by the invention, which uses technical means make it possible to adapt to several type of collection terminal:
electronic payment terminals (EPTs) for merchants where the detail of the services provided is not necessary;
centralised management systems when such exist (car hirers for example);
payment systems (particularly in place at petrol stations, and
hotel management systems.

The central server 3 transmits a message confirming correct receipt of the data at the terminal so as to validate the implementation of said transaction, during a step 13.

The invoice generated is archived in the database of the central server 3 in order subsequently to be transmitted to the server 21 of the technical platform of the company 7, a tax authority or to the server of the merchant, automatically or at the request of one of these. This transmission can in particular be performed from the electronic mail server included in the central server 3.

The central server 3 subsequently determines the place where the transaction is performed from elements included in the list of the ordered set of data elements recovered, such as the address and the country in which the merchant is situated.

From the determination of the place of the transaction, the processing means are able, according to the identification of tax criteria in force in the given place, to apply calculation operations to the amount of the invoice. These calculation operations make it possible to determine the amount of reimbursement, relating to the tax taken into account for obtaining the amount of the invoice, and said reimbursements are able to be obtained from the tax authority of the country of the place of this transaction.

These criteria make it possible to determine for example if an invoice is eligible for a reimbursement. They take into account for example the elements according to which the bearer is a natural or legal person, or acts for a legal person, such as for example the VAT rate to which said legal person is possibly subject or elements relating to the bearer that may have an influence on his right to reimbursement, such as his capacity as administrator for example.

The central server 3 comprises in its database instructions for performing tax calculations particular to each country and applicable according to criteria with which these operations are associated. These instructions are used during calculation operations.

Once the amount of the reimbursements is determined, the central server 3 sends a reimbursement request to the reimbursement server 6 dedicated to this purpose, during a step 22. This request comprises in particular the information necessary for this tax authority to make the reimbursement, such as:
for the company concerned: name, address, country, registration number (Trade and Companies Register), legal form, share capital, SIREN number (company register identification system) and the individual identification number, bank details, and
other elements that may be required by the tax authority of the country concerned.

It should be noted that the company registration number is here a generic name for any equivalent system. The company registration is therefore presented as a record that centralises a certain number of items of legal information on companies.

In another embodiment, a form in a paper format meeting the requirements of the tax authority is generated and transmitted by post to this authority.

As soon as this request for reimbursement is received by the tax authority, this reimbursement is then made according to the payment methods in force to the bank account of the company.

This reimbursement procedure is carried out automatically by the central server 3 as soon as the transaction is performed. However, it may also be carried out at the request of the company, if the latter is registered with the central server 3 to benefit from this service. The reimbursement server is able to transmit to the central server 3 a request specifying that the request for reimbursement has been correctly taken into account and confirmation of this reimbursement during a step 23.

It will be noted that the registration procedure for benefitting from the service dispensed by the central server 3 enables the bearer, during steps 18 and 19, by connecting to the web server of the central server 3, to manually prepare, check and edit digital invoices in accordance with the various national legislations concerned. It also enables a merchant registered for this service to consult and import the invoices drawn up on his behalf and to access complementary services of analysis of his customers.

It will be noted that the merchant and the bearer or company of the bearer have, at the central server, an account in which they find archived all the invoices in an electronic format concerning them or concerning their activity.

The bearer or the company of the bearer will also find information on the reimbursements already made or in the course of being made along with the steps being performed.

The invention thus proposes a simple and economical solution for ensuring rapid deployment relying in particular on existing payment terminals and data collection networks in order to make them assume a new function not planned when they were set up.

In addition, the invention enables for example a company to be able to recover VAT due by virtue of business travel expenditure incurred in Europe, Japan, Canada, South Korea and in other countries that authorise such reimbursement.

By way of example the merchant is a restaurant in the United Kingdom. When the bill is brought to him, the bearer presents his identifier in the form of a card (which does not have a payment function). After having indicated the total amount of the bill including VAT, passing the card through the electronic payment terminal activates the onboard software, which recognises, by means of the information coded in the identifier, that the company employing the bearer is French, that the card is activated for international use and that it does not require asking a question relating to the allocation of the expenditure to a project code. The terminal asks a first question, in English: “number of guests?”. When the head waiter has replied that there are 5 guests, the terminal proposes a second question determined according to the combination of the parameterising of the terminal (a restaurant in the United Kingdom) and the identifier of the bearer. A specific question is posed in French, the language of the bearer: “number of guests external to the company?”. The bearer replies two. Consequently the payment terminal transmits to the central server an ordered set of data that enables the central server to draw up an original invoice on behalf of the restaurant in the United Kingdom, in the name of the company employing the bearer with the necessary legal information: date, invoice number, wording: “five complete meals” with an indication of the price excluding VAT, the amount and rate of VAT and the price including VAT. The ordered set of data moreover makes it possible to establish a request for reimbursement of VAT in the name of the company employing the bearer, and to request the reimbursement of three fifths of the amount of VAT indication on the invoice, VAT on external guests not being recoverable in the United Kingdom.

In a second example, the restaurant is this time situated in France, the bearer is German and his identifier indicates that the terminal must request a project allocation code. After having entered the total amount including VAT and he has replied to the question on the number of guests, the terminal requests the amount including VAT for the consumption of wine and alcohol (taxed at the normal rate). This question is posed in French, and then the terminal proposes, in German, to the bearer, to allocate a project code to the expenditure. The ordered set of data makes it possible to establish an invoice on behalf of the

French restaurant in the name of the German employing company that details:
“five complete means”, amount excluding VAT, reduced VAT rate, VAT amount, amount including VAT
on a second line “drinks”, amount excluding VAT, normal VAT rate, amount of VAT, amount including VAT,
total of the invoice excluding VAT, total VAT, total including VAT.

The information relating to the allocation of a project code that will for example subsequently enable the employing company to reinvoice said expenditure to the client concerned is attached, for the bearer and his employing company, to this invoice, which is available both for the merchant and for the bearer and his employing company.

In a third example, the restaurant is in Belgium and, although the bearer of the card indicates that it is not necessary to propose the allocation of project code when the information is entered, the terminal proposes it routinely, this information being necessary for filling in the Belgian recovery form.

In another example, the merchant is an independent hotel in France that mainly offers bed and breakfast, bar and restaurant services. The bearer presents as an identifier a twinned card that adds the payment function to the process described by the present patent. After having indicated the amount of the total invoice including VAT, the terminal recognises that it is a foreign twinned card activated for international use. The terminal then requests the amount for the accommodation services including VAT, as well as the number of person-nights, and then the total bar, restaurant and breakfast expenditure including VAT. In the absence of other services, the terminal requests whether some or all of the accommodation concerns a third party outside the company employing the bearer (only accommodation expenditure reimbursable with regard to French VAT). Finally, the terminal requests confirmation of the total amount including VAT and proceeds with payment of the transaction.

In another example, in the same hotel, a customer who is not yet a bearer of an identifier is offered a temporary identifier that enables him to benefit from the process whereas his employer has not yet carried out the prior necessary registration procedure described in paragraph 38. The invoice is drawn up in the name of the company of the bearer when it has carried out said registration procedure.

In another example, an element of the identifier of the bearer forces, if possible, the terminal to make a request to the central server, in real time, in order for example to download the lists of project codes available.

In another example, the merchant is a service station in France and the questions posed concern the number of vehicle doors and the type of fuel used.

In the majority of the above examples the invoice number is generated by the payment terminal. Another implementation however enables the central server to generate this number.

Thus the invention is naturally not limited to the example embodiments described and illustrated. It is also not limited to these examples of execution and to the variants described.

1-11. (canceled)

12. Method of managing invoicing for an electronic transaction relating to the purchase of a good and/or service by a bearer, comprising the following steps:
collecting at least one element identifying the bearer included in a data carrier by reading a terminal;
recovering an ordered set of data elements corresponding to characteristics of said transaction from an application interface previously downloaded and entry means of said terminal;
transmission of said at least one identification element and the ordered set of data elements recovered to a central server;
generation of an invoice in an electronic format by processing means of the central server from identification data associated with the identification element in a database of said server and the ordered set of data elements recovered; and
archiving said invoice in an electronic format in the database of the central server.

13. Method according to claim 12, in which said data recovery step comprises a substep of selecting elements constituting said application interface according to at least one criterion defined by said identification element, said selection of elements making possible obtaining the ordered set of data elements corresponding to the characteristics of said transaction.

14. Method according to claim 12, comprising a preliminary step of registration:
of the bearer in which the identification data associated with the identification element of the bearer are recorded in the database of the central server, and
of a merchant, for which an individual identification number is created and archived in the database of the central server.

15. Method according to claim 12, in which the identification data relate, in the database of the central server, to a first name and surname, a name of a company employing the bearer, and a physical and electronic address of the bearer and company.

16. Method according to claim 12, in which the invoice in an electronic format is archived in the database of the central server.

17. Method according to claim 12, in which the ordered assembly of recovered data elements comprises information concerning:
a merchant: individual identification number;
the bearer: identification element;
the transaction: date and number of the transaction, quantity and name of the goods and/or services sold;
the financial elements: an amount excluding and/or including VAT of the goods and/or services sold, tax applicable; and
responses to specific questions posed according to a context of the transaction.

18. Method according to claim 17, comprising:
a step of management of reimbursement of data relating to said tax in which:
the company employing the bearer transmits to the central server a request for recovering said tax through the communication network,
the central server determines whether the invoice in an electronic format is eligible for a reimbursement of said tax, and
the central server sends, through a commutation network, at least one request for reimbursement of said tax to reimbursement servers dedicated to the tax, said request being able to consolidate several invoices in the name of the same business.

19. Method according to claim 17 in which the tax is value added tax.

20. System for managing invoicing for an electronic transaction relating to a purchase of a good and/or service by a bearer, comprising a terminal connected to a central server from a communication network, the terminal having reading means for extracting at least one identification element for a data carrier and archiving said identification element and an ordered set of data elements relating to the transaction in storage means of the terminal before transmitting the identification element and the ordered set of data elements to the processing means of the central server so as to generate an invoice in an electronic format relating to said transaction and optionally sending a message confirming a making of a payment validating a performance of said transaction.

21. System according to the claim 20, in which said terminal is an electronic payment terminal.

22. System according to claim 20, in which the data carrier is an integrated-memory identification card.
